(19) United States
(12) Patent Application Publication
(10) Pub. No.: US 2019/0016583 A1
(43) Pub. Date: Jan. 17, 2019

(54) VEHICLE PLATOON REFUELING

(71) Applicant: Ford Global Technologies, LLC, Dearborn, MI (US)

(72) Inventors: Aed M. Dudar, Canton, MI (US); Kenneth James Miller, Canton, MI (US); Thomas G. Leone, Ypsilanti, MI (US)

(73) Assignee: Ford Global Technologies, LLC, Dearborn, MI (US)

(21) Appl. No.: 15/651,032

(22) Filed: Jul. 17, 2017

(51) Int. Cl. B67D 7/04; G05D 1/02; G06Q 10/06; G08G 1/00

(52) U.S. Cl. CPC B67D 7/0401; G05D 1/0295; G07F 13/025; G08G 1/22; G06Q 10/06311

(57) ABSTRACT

Upon a determination to refuel a platoon of vehicles, a respective fuel inlet location is identified for each of the vehicles in the platoon. Based on the fuel inlet locations, a refueling location is selected. The platoon is navigated to the refueling location.

### BACKGROUND

Vehicles, particularly autonomous vehicle that may lack human operators, can travel in platoons, i.e., groups of vehicles wherein each vehicle in the platoon follows instructions from a lead vehicle and/or central computer to navigate. One or more vehicles in a platoon can require refueling. Problems can arise in managing platoon refueling operations.

### BRIEF DESCRIPTION OF THE DRAWINGS

FIG. 1 is a block diagram of an example vehicle platoon system for controlling a stopping place of a vehicle.

FIG. 2 illustrates an example platoon of vehicles.

FIG. 3A illustrates an example vehicle platoon refueling operation at a fuel station.

FIG. 3B illustrates another example vehicle platoon refueling operation at a fuel station.

FIG. 4 is a flow diagram illustrating an example process for a vehicle platoon refueling operation.

### DETAILED DESCRIPTION

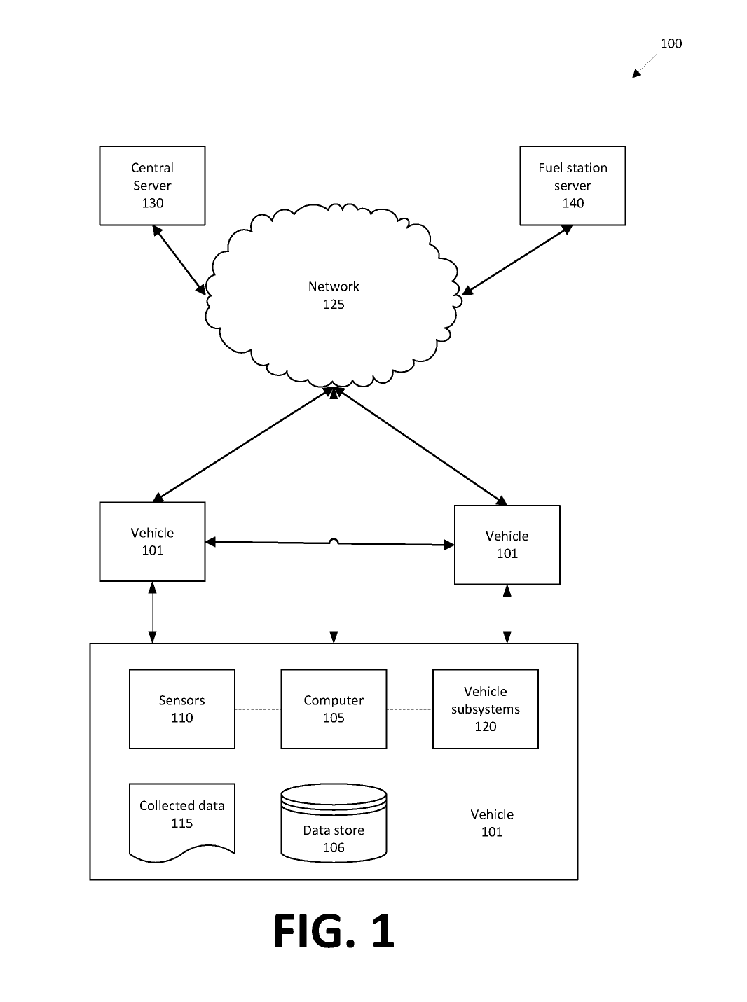

As illustrated in FIG. 1, a vehicle platoon system 100 includes two or more vehicles 101; for ease of illustration three vehicles 101 are shown in FIG. 1. Each of the vehicles 101 includes a computer 105, and associated data store 106, sensors 110 providing collected data 115, as well as various vehicle subsystems 120 that can be controlled by the computer 105 and/or provide data 115 thereto. (For ease of illustration, the elements 105, 106, 110, 105, and 120 are shown with respect to one of the vehicles 101; it is to be understood that like elements may be included in each of the vehicles 101 in the system 100.)

The computer 105 is generally programmed for communications on a vehicle 101 network, e.g., including a communications bus, as is known. Via the network, bus, and/or other wired or wireless mechanisms (e.g., a wired or wireless local area network in the vehicle 101), the computer 105 may transmit messages to various devices in a vehicle 101 and/or receive messages from the various devices, e.g., controllers, actuators, etc., included in subsystems 120, as well as sensors 110. Alternatively or additionally, in cases where the computer 105 actually comprises multiple devices, the vehicle network may be used for communications between devices represented as the computer 105 in this disclosure. In addition, the computer 105 may be programmed for communicating with the network 125, which, as described below, may include various wired and/or wireless networking technologies, e.g., cellular, Bluetooth®, Bluetooth® Low Energy (BLE), wired and/or wireless packet networks, etc.

The data store 106 may be of any known type, e.g., hard disk drives, solid state drives, servers, or any volatile or non-volatile media. The data store 106 may store the collected data 115 sent from the sensors 110.

The computer 105 includes or is connected to a communication interface that can be implemented via circuits, chips, or other electronic components that can facilitate wireless communication with other vehicles or infrastructure devices via, e.g., the Dedicated Short-Range Communication (DSRC) protocol. Via the communication interface 110, the computer 105 may be programmed to wirelessly transmit messages to, and receive messages from, other vehicles 101 and infrastructure devices, e.g., the central server 130. The received messages may be transmitted and/or interpreted to provide instructions for vehicle 101 subsystems 120. Messages including such control signals may be transmitted according to any number of wireless communication protocols, including DSRC.

Sensors 110 may include a variety of devices. For example, as is known, various controllers in a vehicle 101 may operate as sensors 110 to provide data 115 via the vehicle 101 network or bus, e.g., data 115 relating to vehicle speed, acceleration, position, subsystem and/or subsystem status, etc. Further, other sensors 110 could include cameras, motion detectors, etc., i.e., sensors 110 to provide data 115 for evaluating a location of a target, projecting a path of a target, evaluating a location of a roadway lane, etc. The sensors 110 could also include short range radar, long range radar, LIDAR, and/or ultrasonic transducers.

Collected data 115 may include a variety of data collected in a vehicle 101. Examples of collected data 115 are provided above, and moreover, data 115 are generally collected using one or more sensors 110, and may additionally include data calculated therefrom in the computer 105, and/or at a central server 130. Collected data 115 may also be provided from vehicle subsystems 120, e.g., an electronic control unit (ECU) in an engine subsystem 120 can provide data relating to engine speed, to provide just one example In general, collected data 115 may include any data that may be gathered by the sensors 110 and/or subsystems 120, and/or computed from such data.

The vehicle 101 may include a plurality of vehicle subsystems 120. As used herein, each vehicle subsystem 120 includes one or more hardware subsystems adapted to perform a mechanical function or operation—such as moving the vehicle, slowing or stopping the vehicle, steering the vehicle, etc. Non-limiting examples of subsystems 120 include a propulsion subsystem 120 (that includes, e.g., an internal combustion engine and/or an electric motor, etc.), a transmission subsystem 120, a steering subsystem 120 (e.g., that may include one or more of a steering wheel, a steering rack, etc.), a brake subsystem 120, a park assist subsystem 120, a movable seat, etc.

When the computer 105 operates the vehicle 101, the vehicle 101 is an “autonomous” vehicle 101. For purposes of this disclosure, the term “autonomous vehicle” is used to refer to a vehicle 101 operating in a fully autonomous mode. A fully autonomous mode is defined as one in which each of vehicle 101 propulsion (typically via a powertrain including an electric motor and/or internal combustion engine), braking, and steering are controlled by the computer 105. A semi-autonomous mode is one in which at least one of vehicle 101 propulsion (typically via a powertrain including an electric motor and/or internal combustion engine), braking, and steering are controlled at least partly by the computer 105 as opposed to a human operator.

The system 100 may further include a network 125 providing communications to and from vehicle 101 computers and/or a central server 130 and one or more fuel station servers 140 (one fuel station server 140 being shown in FIG. 1 for ease of illustration). The computer 105 may further be programmed to communicate with one or more remote sites such as the server 130, via the network 125, such remote site possibly including a data store 135. The network 125 represents one or more mechanisms by which a vehicle computer 105 may communicate with a remote server 130. Accordingly, the network 125 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

The central server 130 is a computing device such as is known, i.e., including one or more processors and memories, and possibly embodied as multiple and/or distributed computing devices. The central server 130 can store, and provide to vehicles 101, information about refueling stations, including a number and locations of pumps, from which a vehicle 101 computer 105 can determine a refueling strategy including creation of two or more sub-platoons of vehicles 101 in a platoon to accommodate fuel inlet positions of respective vehicles 101, i.e., each vehicle 101 has a respective fuel inlet position (typically on a right or left side of the vehicle rearward of a rear-most door). That is, the respective fuel inlet locations are compared to respective locations and/or orientations of pumps. Alternatively or additionally, such determination can be made by the server 130 and provided to one or more vehicles 101 in a platoon.

A fuel station server 140 is likewise a computing device such as is known, i.e., including one or more processors and memories, and possibly embodied as multiple and/or distributed computing devices. The fuel station server 140 can store, and provide to vehicles 101 and/or to the central server 130, information about refueling stations, including a number and locations of pumps, from which the refueling strategy can be determined.

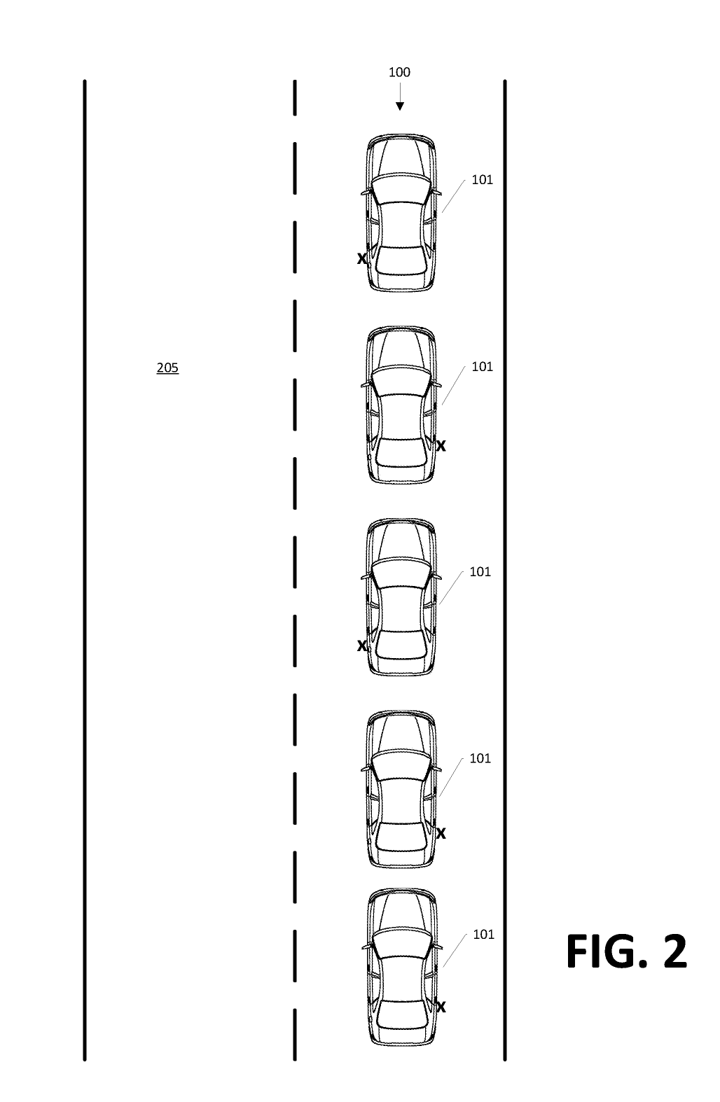

FIG. 2 illustrates an example platoon 200 of vehicles 101 traveling on a roadway 205. A platoon for purposes of the present disclosure is two or more vehicles 101 traveling in cooperation with one another, typically with one of the vehicles 101 serving as a lead vehicle, i.e., providing navigation instructions to other vehicles 101 and the platoon 200 (the other vehicles 101 being referred to as following vehicles). A platoon 200 includes two or more, typically 2 to 25, vehicles 101. Each vehicle 101 in the platoon 200 typically includes a communications interface as mentioned above for vehicle to vehicle (V2V) communications to allow the vehicles 101 to platoon, e.g., to travel while closely spaced. V2V communications are wireless, and generally but not necessarily radio frequency (RF) communications, and can be performed according to known protocols, such as BLUETOOTH®, DSRC, etc. Accordingly, platooning vehicles 101 can accelerate, decelerate and stop substantially in unison, thereby increasing the capacity of roads and increasing safety by eliminating sources of human error. Platooning can increase fuel economy by reducing air resistance, reduce traffic congestion in big cities, provide shorter commuting time during peak traffic hours, and permit occupants to be inattentive to driving at times, for example, highway trips.

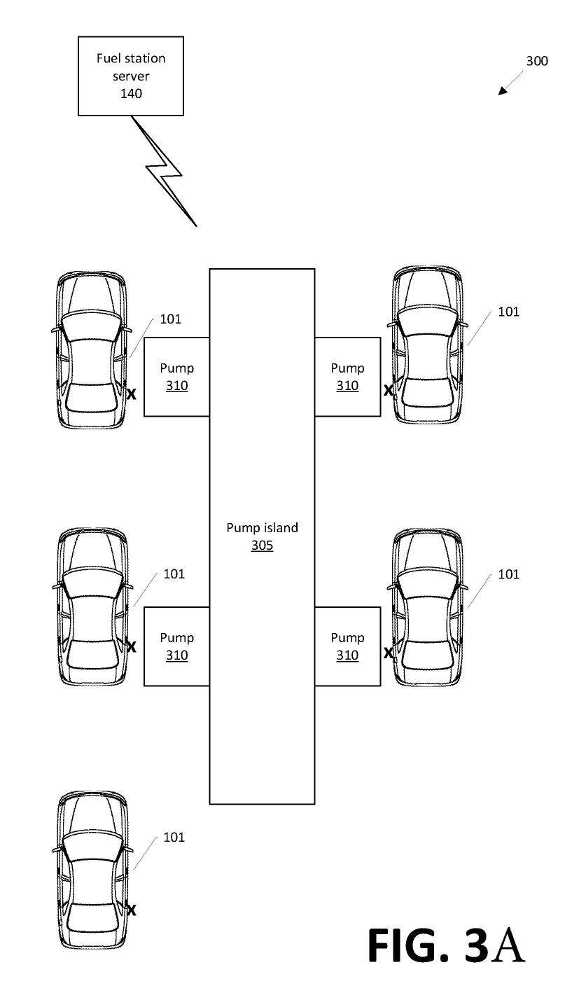

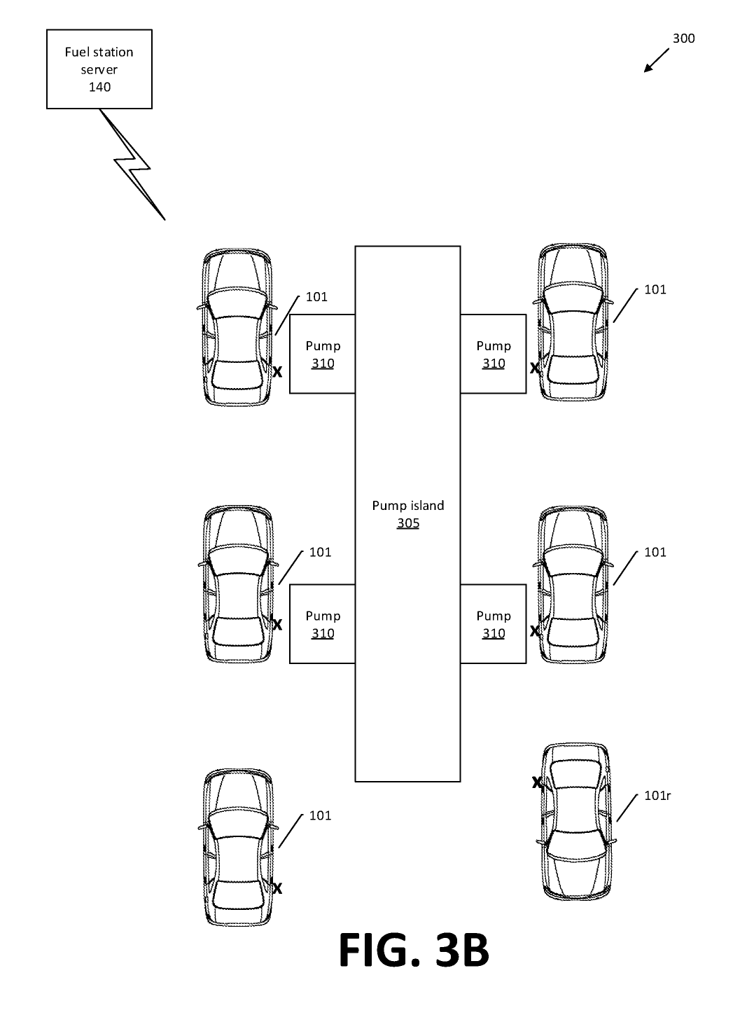

Vehicles 101 in a platoon 200 can have different configurations, e.g., with respect to placement of seats, doors, powertrain, etc. Of particular relevance to the present disclosure is that vehicles 101 in a platoon 200 can have fuel inlets in different positions. For example, although most passenger cars presently operating have fuel inlets on a side of the passenger car, there is no rule for whether a fuel inlet is located on a left side or a right side of a vehicle 101. In FIGS. 2 and 3, an “X” on either a left or right side of each respective vehicle 101 denotes a fuel inlet position. A fuel inlet position as that phrase is used herein means a location or position on a vehicle 101 body at which a fuel inlet, such as a plug for electric charging, opening to a fuel tank for liquid fuel, etc., is located. As can be seen, in the exemplary platoon 200, to vehicles 101 have fuel inlets on a left side, and three vehicles 101 have a fuel inlet on a right side. A problem solved in the present disclosure is how to efficiently provide for refueling of autonomous vehicles 101 in the platoon 200, where fuel inlets on different sides of various vehicles 101 prevents each vehicle 101 from remaining in the platoon 200 during refueling.

FIG. 3A illustrates an example vehicle 101 platoon 200 refueling operation at a fuel station 300, conducted to accommodate fuel inlet positions on respective left and right sides of various vehicles 101 in the platoon 200. The vehicles 101 in the platoon 200 have been split into respective sub-platoons, a first sub-platoon being arranged from vehicles 101 having fuel inlet positions on a right side of the vehicle; this sub-platoon arranges itself at a left side of a pump island 305 including pumps 310. A second sub-platoon is arranged from vehicles 101 having fuel inlet positions on a left side of the vehicle 101; this sub-platoon arranges itself at a right side of the pump island 305 including additional pumps 310.

FIG. 3B illustrates another example vehicle 101 platoon 200 refueling operation at a fuel station 300, conducted to accommodate fuel inlet positions on respective left and right sides of various vehicles 101 in the platoon 200. In the example of FIG. 3B, the platoon includes six vehicles 101, one of which (designated in FIG. 3B as the vehicle 101r) is positioned in a sub-platoon to approach a fuel island 305 in reverse for positioning for refueling at a pump 310. This is because, in the platoon 200 of the example of FIG. 3B, four vehicles 101 (including the vehicle designated 101r) have fuel inlet positions on a right-hand side, and two have a fuel inlet position on a left-hand side. Thus, for most efficient refueling at the available pump island 310, which has two pumps 310 on each side thereof, the vehicle 101r is operated in reverse for refueling in its sub-platoon.

Further, it should be noted that, historically, many vehicles had fuel inlet positions at a rear (typically in a center position, e.g., behind a license plate) of the vehicle. Very few if any current vehicles are so configured. However, if such vehicles do exist or are used in the future, they could be positioned in a subplatoon designated either for refueling on a left or right side of vehicles 101 in the subplatoon.

The fuel station server 140 can be in wireless communication, e.g., using Bluetooth, WiFi®, or the like, with one or more pump 310 controllers that could be mounted in or on the pump island 310 (not shown for ease of illustration), i.e., computers including processors and memories such that the controllers are programmed to control the pumps 310 for refueling vehicles 101. Each pump 310 can include a robot arm or the like, such as may be known, to control the placement of a fuel hose, nozzle, plug, etc., to refuel a vehicle 101 via its fuel inlet. It is to be understood that refueling means other than pumps 310 for liquid fuel could be provided at a fuel station 300, and that the principles therein could apply to such other refueling means. For example, a fuel inlet in an electric vehicle 101 or plug-in hybrid electric vehicle 101 (PHEV) could be an electrical socket or plug; in the context of this disclosure and the following claims a “pump 310,” “a fuel pump,” etc., should, unless explicitly stated otherwise, be understood generally as any one of a number of possible fuel-delivery mechanisms, and could include a plug delivering electricity, a nozzle delivering natural gas or other gas fuel (such as hydrogen), as well as a nozzle to deliver liquid fuel such as gasoline or diesel fuel.

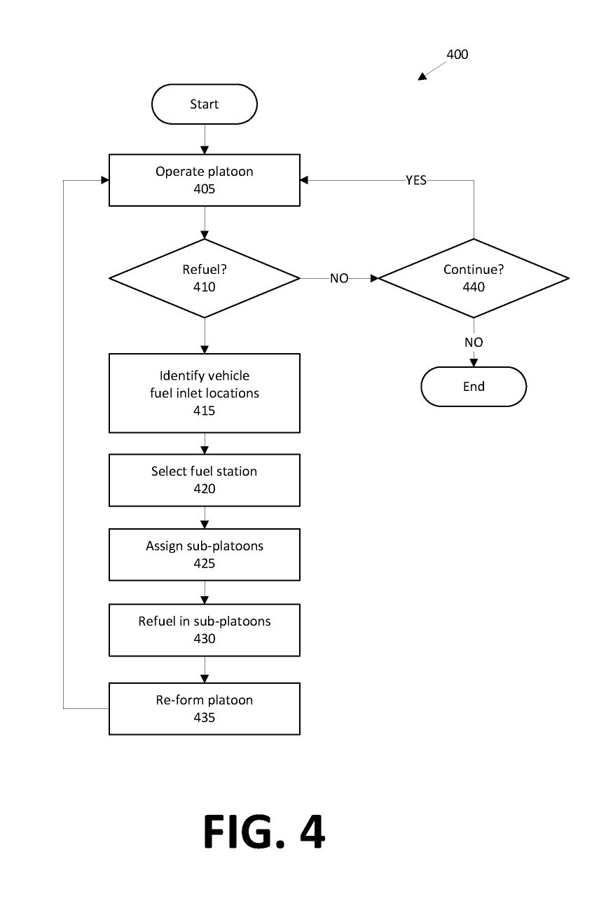

FIG. 4 illustrates an example process 400 for a vehicle platoon refueling operation. The process 400 begins in a block 405, in which a platoon 200 travels on a roadway 205. As mentioned above, operation of the platoon 200 may be controlled by a computer 105 in a lead vehicle 101 that uses V2V communications to transmit instructions to following vehicles 101. Alternatively or additionally, the lead vehicle 101 and/or following vehicles 101 could receive instructions, e.g., relating to spacing between vehicles 101, speed, accelerating, decelerating, turning, stopping, etc., from a central server 130 via the network 125.

Next, in a block 410, a determination is made whether to conduct a platoon 200 refueling operation. If yes, a block 415 is executed next. Otherwise, the process 400 proceeds to a block 440.

The determination to conduct a platoon 200 refueling operation may be made according to program instructions in a computer 105 in a lead vehicle 101. For example, the computer 105 could be programmed to receive data from each vehicle 101 in the platoon 200 indicating a fuel level (e.g., miles to empty, percentage full of fuel tank, battery, etc.). Further, the computer 105 could be programmed to determine that a refueling operation for the platoon 200 should be conducted for some or all vehicles 101 in the platoon 200. For example, the computer 105 could be programmed to determine to conduct the refueling operation upon determining that at least one vehicle 101 in the platoon 200 had a fuel level of 25 percent or less, e.g., a liquid fuel tank was one quarter full or less.

Moreover, the computer 105 could be programmed to determine to conduct the refueling operation for all vehicles 101 in the platoon upon determining that at least one vehicle 101 fuel level was below a predetermined threshold (e.g., 25 percent), or the computer 105 could be programmed to determine to conduct the refueling operation only for vehicles 101 whose fuel level is below the predetermined threshold set to trigger the refueling operation, or for vehicles 101 whose fuel level is below some other predetermined threshold. For example, a fuel level of 25 percent or less in any vehicle 101 in the platoon 200 could trigger a refueling operation, and the refueling operation could then be performed for all vehicles 101 in the platoon, or alternatively could be performed only for vehicles 101 having fuel levels below 25 percent, or yet further alternatively could be performed only for vehicles 101 having fuel levels below 50 percent.

Yet further, the determination to conduct a refueling operation could take into account a proximity of refueling stations 300 with respect to a current location of the platoon 200 and/or could take into account configurations, e.g., a number of available pumps 310, whether pumps 310 at a refueling station 300 are arranged to accommodate vehicles 101 traveling in a same direction having fuel inlets on different sides at a same time, etc.

Alternatively, the determination to conduct the refueling operation could be made in the server 130. For example, each vehicle 101 could transmit fuel level data to the server 130, or a lead vehicle 101 could transmit fuel level data for each vehicle 101 in a platoon 200 to the server 130. The server 130 could then make the refueling determination as described above.

In the block 415, which may be executed following the decision block 410, a fuel inlet position, e.g., left side or right side, is identified for each vehicle 101 in the platoon 200. For example, each vehicle 101 may supply this information to the platoon 200 lead vehicle 101, which can then store, in an association with an identifier for each respective vehicle 101 and the platoon 200, its fuel inlet position. In another example, a lead vehicle 101 computer 105 or the central server 130 could be provided with fuel inlet position information from an external source, such as a camera, e.g., mounted on an unmanned aerial vehicle (UAV), infrastructure such as a utility pole or the like, etc. In yet another example, the server 130 and/or a lead vehicle 101 computer 105 could receive information including a make, model, and model year for each vehicle 101 in the platoon 200, and could retrieve stored information about a fuel inlet position for each vehicle 101 in association with its make, model, and model year.

Next, in the block 420, a refueling location, e.g., a location of a fuel station 300 is selected for the refueling operation, e.g., according to programming in a lead vehicle 101 computer 105 or central server 130. For example, a computer 105 or 130 could retrieve stored map data including locations of fuel stations 300 within a predetermined radius of a current location of the platoon 200. Moreover, the computer 105 or 130 could be programmed to consider only fuel stations 300 on a planned route of travel of the platoon 200, e.g., that would not result in a detour of more than a predetermined distance and/or time, e.g., two miles, five miles, ten miles, five minutes, ten minutes, etc.

Yet further, the computer 105 or 130 could consider only fuel stations 300 having a predetermined number of pumps 310, and where the pumps 310 have locations and/or orientations (an orientation in this context being a direction in which a pump 310 is facing for refueling a vehicle 101) that are arranged to accommodate refueling of vehicles 101 facing a same direction but having fuel inlet positions on different respective vehicle 101 sides. For example, if a platoon 200 included 12 vehicles, and a computer 105 or 130 was programmed to consider only fuel stations 300 having at least one-third the number of pumps 310 as vehicles 101 in a platoon, fuel stations 300 having less than four pumps 310 would be excluded from consideration. Moreover, a fuel station 300 having four or more pumps 310, but where all of the pumps 310 were arranged so as to be accessible only from one side (right or left) when facing in a same direction, would be excluded from consideration in this example.

Yet further, the computer 105 or 130 could be programmed to communicate with, e.g., query, a fuel station server 140 of a selected fuel station 300, e.g., via the network 125, to determine pump 310 availability at the selected fuel station 300, e.g., at a present time, or predicted for an arrival time at the fuel station 300 of the platoon 200. The computer 105 or 130 could exclude from consideration any fuel station 300 indicating that its pumps 310 are not or are not predicted to be available for the platoon 200. Alternatively or additionally, the computer 105 or 130 could be programmed to select only a fuel station 300 whose server 140 excepts a reservation of pumps 310 for the platoon 200 at a predicted arrival time.

Next, in a block 425, the computer 105 or 130 assigns each vehicle 101 in the platoon 200 to one of two or more sub-platoons. Determination of sub-platoons and assignment of vehicles 101 to respective sub-platoons is typically based on a location and orientation of available pumps 310 at the fuel station 300. The computer 105 or 130 can first determine a number of sub-platoons according to a number of vehicles 101 in the platoon 200 and/or an arrangement of pumps 310 at the selected refueling station 300. For example, the computer 105 or 130 could be programmed to implement at most two sub-platoons if a number of vehicles 101 in the platoon 200 was below a predetermined threshold, e.g., four vehicles 101. Further, the computer 105 or 130 could be programmed to determine a number of pumps 310 at the selected refueling station 300 that, based on a direction of travel of the platoon 200, can accommodate each of right hand side and left-hand side fuel inlet positions. The computer 105 or 130 could then determine a number of sub-platoons by equally dividing into sub-platoons vehicles 101 having right-hand side fuel inlets among pumps 310 accommodating right-hand side refueling, and likewise equally dividing into sub-platoons vehicles 101 having left-hand side fuel inlets among pumps 310 accommodating left-hand side refueling. (In each case, the computer 105 or 130 could assign odd vehicles 101 to respective sub-platoons in the event that this division resulted in remainders.) Further, if one or more vehicles 101 in the platoon 200 are not to be refueled, such vehicle(s) 101 could be assigned to a sub-platoon for vehicles 101 not requiring refueling and/or could be directed to a parking or standing area of the fuel station 300 to await completion of the refueling operation and re-formation of the platoon 200. Yet further, in the event that a vehicle 101 has a fuel inlet position that is neutral with respect to refueling (e.g., in a center front or center rear of a bumper or fascia), that vehicle 101 could be assigned to a sub-platoon randomly or, if possible, in a manner to make platoon 200 refueling most efficient, e.g., to balance subplatoon sizes so that a number of vehicles 101 in respective subplatoons are equal or as close to equal as possible.

Next, in a block 430, the platoon 200 navigates to the selected refueling station 300, breaks into the determined sub-platoons, and performs the refueling operation. In some examples, e.g., where a refueling station 300 was not contacted ahead of time to determine pump 310 availability, the platoon 200 may arrive at the refueling station 300 to find that pumps 310 are unavailable. For example, camera sensors 110 can provide images of a refueling station 300 including a presence of other vehicles blocking pumps 310. In such cases, the platoon 200 may navigate unavailable roadways, e.g., drive around a city block, until pumps 310 are available. Alternatively or additionally, if pumps 310 are unavailable or remain unavailable for more than a predetermined amount of time, e.g., five minutes, 10 minutes, etc., then (although not shown in FIG. 4) the process 400 may return to the block 422 select a different refueling station 300.

In any event, when pumps 310 are available for one or more determined sub-platoons in the platoon 200, the refueling operation can begin for the sub-platoon whose pumps 310 are available. Each sub-platoon re-fuels at selected pumps 310, e.g., as illustrated in FIG. 3. As seen in FIG. 3, multiple vehicles 101 in a sub-platoon can refuel at a same time if pumps 310 are available.

Next, in a block 435, the sub-platoons are unformed and the platoon 200 is re-formed from sub-platoons as the respective sub-platoons complete refueling. For example, a lead vehicle 101 computer 105 may instruct each following vehicle 101 concerning a position to assume in the platoon 200 when it's refueling is complete.

Following the block 435, the process 400 returns to the block 405.

Further, in a block 440, which may follow the block 410 (or could follow the block 405, although not shown in FIG. 4), a determination is made whether to continue the process 400. For example, a lead vehicle 101 computer 105 or the server 130 in communication there with could determine to and the process 400, e.g., when a platoon 200 arrives at a planned destination. However, if the process 400 is to continue, e.g., because the platoon 200 is navigating to a planned destination, then the process 400 may return to the block 405.

As used herein, the adverb “substantially” modifying an adjective means that a shape, structure, measurement, value, calculation, etc. may deviate from an exact described geometry, distance, measurement, value, calculation, etc., because of imperfections in materials, machining, manufacturing, data collector measurements, computations, processing time, communications time, etc.

Computers 105 generally each include instructions executable by one or more computers such as those identified above, and for carrying out blocks or steps of processes described above. Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in the computer 105 is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 500, one or more of the steps could be omitted, or the steps could be executed in a different order than shown in FIG. 5. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

1. A computer programmed to:
upon a determination to refuel a platoon of vehicles, identify a respective fuel inlet position for each of the vehicles in the platoon;
based on the fuel inlet positions, select a refueling location; and
navigate the platoon to the refueling location.

2. The computer of claim 1, further programmed to make the determination to refuel the platoon.

3. The computer of claim 1, further programmed to assign each of the vehicles in the platoon to a respective one of a plurality of sub-platoons prior to arrival at the refueling location.

4. The computer of claim 3, further programmed to assign each of the sub-platoons to one of a plurality of fuel pumps at the refueling location.

5. The computer of claim 3, further programmed to assign each of the vehicles in the platoon to a sub-platoon according to each vehicle's respective fuel inlet position.

6. The computer of claim 3, further programmed to unform the sub-platoons and to re-form the platoon after the vehicles are refueled.

7. The computer of claim 3, further programmed to assign at least one of the vehicles to operate in one of the sub-platoons in reverse.

8. The computer of claim 1, further programmed to query a server at a fuel station for information about pumps at the fuel station.

9. The computer of claim 1, further programmed to determine, upon arrival at the refueling location, that pumps are not available for refueling, and to execute navigation of a route by the platoon until pumps are available for the refueling.

10. A computer, programmed to:
identify a refueling location for a platoon of vehicles; and
assign each vehicle in the platoon to one of a plurality of sub-platoons according to a respective fuel inlet position of each vehicle and at least one of respective locations and orientations of pumps at the refueling location.

11. A method, comprising:
upon a determination to refuel a platoon of vehicles, identifying a respective fuel inlet position for each of the vehicles in the platoon;
based on the fuel inlet positions, selecting a refueling location; and
navigating the platoon to the refueling location.

12. The method of claim 11, further comprising making the determination to refuel the platoon.

13. The method of claim 11, further comprising assigning each of the vehicles in the platoon to a respective one of a plurality of sub-platoons prior to arrival at the refueling location.

14. The method of claim 13, further comprising assigning each of the sub-platoons to one of a plurality of fuel pumps at the refueling location.

15. The method of claim 13, further comprising assigning each of the vehicles in the platoon to a sub-platoon according to each vehicle's respective fuel inlet position.

16. The method of claim 13, further comprising unforming the sub-platoons and to re-form the platoon after the vehicles are refueled.

17. The method of claim 13, further comprising assigning at least one of the vehicles to operate in one of the sub-platoons in reverse.

18. The method of claim 11, further comprising querying a server at a fuel station for information about pumps at the fuel station.

19. The method of claim 11, further comprising determining, upon arrival at the refueling location, that pumps are not available for refueling, and executing navigation of a route by the platoon until pumps are available for the refueling.
